(19) United States
(12) Patent Application Publication
(10) Pub. No.: US 2005/0181775 A1
(43) Pub. Date: Aug. 18, 2005

(54) Alert notification service

(75) Inventors: Clarence P. Rideout JR., St. Petersburg, FL (US); Hunt K. Brand, Belleair Bluffs, FL (US); Michael B. Murdock, Derby, KS (US); Joseph J. Depaolo, Palm Harbor, FL (US); John A. Neal, Seminole, FL (US)

Correspondence Address: C. Douglas McDonald. Esq.;Carlton Fields, P.A., P.O.Box 3239, Tampa, FL, 33601-3239, US

(73) Assignee: Readyalert Systems, LLC

(21) Appl. No.: 11/057,683

(22) Filed: Feb. 14, 2005

Related U.S. Application Data
(60) Provisional application No. 60/544,836, filed on Feb. 13, 2004.

(51) Int. Cl. G06F 15/16

(52) U.S. Cl. 455/414.3; 340/7.28; 455/404.1; 379/37; 709/206; 340/7.48; 340/531

(57) ABSTRACT

Systems, methods, computer programs, and related equipment for providing an alert notification service are provided. One embodiment is an alert notification service provider comprising: means for interfacing with at least one alert recipient and an alert originator via a web site; means for managing a user profile associated with the at least one alert recipient, the user profile associating contact information for at least one mobile communication device to receive an alert notification from the alert originator with a private universal contact address accessible by the alert originator; and means for delivering the alert notification to the at least one mobile communication device based on the private universal contact address.

### CROSS-REFERENCE TO RELATED APPLICATION

This application claims the benefit of U.S. Provisional Application No. 60/544,836, filed Feb. 13, 2004, which is hereby incorporated by reference in its entirety.

### BACKGROUND

There are various communication systems that enable individuals and/or organizations to conveniently communicate with each other. People routinely use voice mail and electronic mail systems for daily communication with each other. The advance of portable communication devices (e.g., mobile phones, personal digital assistants, Internet-enabled devices) enables people to send messages, information, etc. to each other—nearly anywhere and anytime. For example, a number of portable communication devices support instant messaging, text messaging, SMS, and electronic mail, to name a few. Users may transmit simple text messages, audio, or multimedia messages.

Despite the existence of numerous types of portable communication devices and communication technologies, however, there is a need in the industry for improved systems, methods, computer programs, and related equipment for providing alert notification services to users.

### SUMMARY

Various embodiments of systems, methods, computer programs, and related equipment for providing an alert notification service are provided. One embodiment comprises a system for providing an alert notification service. One such system comprises (a) a web-based user interface for interfacing with an alert originator and a plurality of alert recipients, (b) a data store for storing profiles associated with the alert recipients, and (c) a transmission center for delivering an alert notification to communication devices associated with the alert recipients. The web-based user interface comprises an alert recipient profile management module and an alert originator administration module. The alert recipient profile management module is configured to enable the plurality of alert recipients to define the profile, which comprises contact information for the at least one communication device to receive the alert notification from the alert originator. The profile links the contact information to a unique universal contact address to be used by the alert originator to identify the corresponding alert recipient. The alert originator administration module is configured to enable the alert originator to initiate the alert notification to be sent to the plurality of alert recipients based on the corresponding unique universal contact addresses. The transmission center delivers the alert notification to the communication devices using the contact information in the profile for the corresponding unique universal contact address.

Another embodiment comprises a method for providing an alert notification service. One such method comprises: enabling at least one alert recipient and an alert originator to register with an alert notification service via a web site; receiving, from the at least one alert recipient via the web site, contact information for at least one personal communication device to receive an alert notification from the alert originator via the alert notification service; associating the contact information with a private universal contact address in a database; enabling the alert originator to initiate the alert notification to be sent to the at least one personal communication device based on the private universal contact address; and delivering the alert notification to the at least one personal communication device by identifying the contact information associated with the private universal contact address.

Yet another embodiment comprises an alert notification service provider comprising: means for interfacing with at least one alert recipient and an alert originator via a web site; means for managing a user profile associated with the at least one alert recipient, the user profile associating contact information for at least one mobile communication device to receive an alert notification from the alert originator with a private universal contact address accessible by the alert originator; and means for delivering the alert notification to the at least one mobile communication device based on the private universal contact address.

### BRIEF DESCRIPTION OF DRAWINGS

FIG. 1 is a block diagram of one of a number of possible embodiments of an alert notification system.

FIG. 2 is a block diagram illustrating the architecture of an embodiment of the alert notification service provider of FIG. 1.

FIG. 3 is a block diagram illustrating an embodiment of a user profile of the database of FIGS. 1 & 2 for implementing various aspects of the alert notification service.

FIG. 4 is a combined block diagram and flow chart illustrating another possible embodiment of an alert notification system.

FIG. 5 is a flow chart illustrating a method for implementing an alert notification service via the systems of FIGS. 1-4.

### DETAILED DESCRIPTION

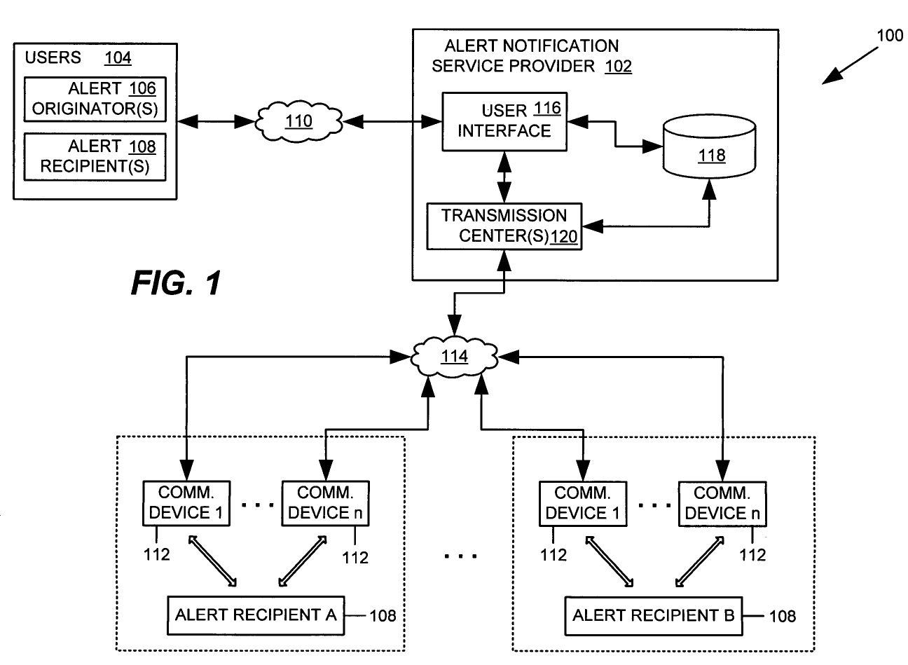

Various embodiments of systems, methods, computer programs, and related equipment for providing an alert notification service are described below with respect to FIGS. 1-5. As an introductory matter, however, one embodiment of an alert notification service will be briefly described. In general, the alert notification service is implemented in a web-based environment using an application service provider (ASP) model. In this regard, an alert notification service provider employs a web site that provides various aspects of the web-based alert notification service to alert recipients and alert originators. For instance, the alert originators and recipients may access the web site to register for, configure, and/or manage the alert notification service.

From the perspective of the alert originator, the alert notification service provides a convenient mechanism for sending alert messages to a number of different individuals or group(s) of individuals (i.e., alert recipients). An alert originator (e.g., an individual, organization, company, club, civic association) may access the web site and register to provide alert messages to individuals or groups of individuals via the alert notification service. The alert notification service enables the alert originator to specify, via the web site, a number of alert recipients to which an alert message is to be delivered. The alert originator may also create the content of the alert message and configure various aspects of the alert message via the web site. The alert notification service also manages alert receipt confirmation messages or other responses from the alert recipients. The confirmations, response, or other messages may be received via the web site or received directly from the communication device(s) under the control of the alert recipients.

From the perspective of the alert recipients, the alert notification service functions as an on-line store of contact information for one or more of the alert recipient's communication devices, communication services, or the like. An alert recipient may access the web site and register for the alert notification service. The alert recipient may identify one or more communication devices to which alert notifications are to be delivered. The alert recipient also provides, via the web site, the associated contact information for the communication device or service. For example, the alert recipient may provide telephone numbers along with information related to the corresponding service providers. It should be appreciated that the alert notification service may support any communication device (e.g., mobile phone, personal digital assistant, pagers, portable communication device), as well as any communication technology (e.g., electronic mail, SMS, text messaging, and instant messaging, to name a few).

The contact information and/or address for each communication device or communication service is maintained by the alert notification service in, for example, a user profile. The user profile is associated with a unique universal contact address linked to the particular alert recipient. In this manner, the contact information for each communication device or communication service may be referenced via the unique universal contact address—rather than the separate addresses and/or contact information for each device or service. The user profile may be securely stored by the alert notification service so that the device or service-specific contact information is not accessible to the alert originator. For example, the alert originator may be able to access the unique universal contact address, while the specific contact information is securely maintained by the alert notification service provider. In other words, the universal contact address enables the alert recipients to receive alert messages without revealing the actual addresses to the alert originator. When sending alert messages, the alert originator identifies the alert recipients by the universal contact address, and the alert notification service uses the universal contact address to determine the device or service-specific contact information used to deliver the alert message.

Having briefly described one embodiment of an alert notification service, various additional embodiments will be described with reference to FIGS. 1-5. FIG. 1 illustrates one embodiment of an alert notification system 100 for providing an alert notification service to users 104 (i.e., alert originator(s) 106 and alert recipient(s) 108). The alert notification service is provided via an alert notification service provider 102 in a web-based ASP environment. As illustrated in FIG. 1, users 104 may interact with access service provider 102 via a communication network 110, which may comprise any network, regardless of the transmission medium, network topology, protocol, or infrastructure. In one embodiment, communication network 110 may be implemented via the Internet, although it should be appreciated that any other network may be employed. Alert originators 106 and alert recipients 108 may register for the alert notification service via user interface 1 16 (e.g., a web site). As described in more detail below, user interface 116 (and the supporting functionality/services) also enables alert originators 106 and alert recipients 108 to manage various aspects of the alert notification service.

As further illustrated in FIG. 1, alert notification service provider 102 delivers the alert messages, on behalf of alert originator 106, to registered communication device(s) 112 associated with alert recipients 108 via transmission center(s) 120. Transmission center(s) 120 support communication with various communication devices, such as, for example, mobile phones, pagers, personal digital assistants, and portable communication devices, to name a few. Alert notification service provider 102 includes a database 118 for storing contact information associated with communication devices 112.

Referring to FIG. 1, in one embodiment, alert notification service provider 102 comprises an Internet or web-based user interface (e.g., user interface 116), a database 118, and one or more transmission centers 120. The user interface allows an alert originator 106 to access forms that specify the recipients, priority, subject, and message for the alert. Once the alert originator enters this information into the form, and clicks the send button, an “Alert Package” is created including alert and session identifications. Thereafter, an Alert Package Initiator e-mail and HTTP message containing the alert and session identifications is sent to each active transmission center 120. Once the primary transmission center receives the Alert Package Initiator, it notifies other transmission centers 120 that it has received the Alert Package Initiator message and requests the Alert Package.

Transmission center 120 then requests the Alert Package by sending a HTTP request with the alert and session identifications to the web site. The web site then creates a complete Alert Package that includes a header, all contact addresses, and individual mail merge fields, and provides the requested information to the transmission center via an extensible markup language (XML) message.

Transmission center(s) 120 send and receive alert messages to communication devices 112 based on their device-specific protocol and communicate the results back to the web site, which updates database 118 with the results. In one embodiment, transmission center(s) 120 may be configured to receive an extendable markup language (XML) package (from the web site) which contains a header record for priority, subject, and message text. The body of the package contains all contact addresses, a delivery method, and any specific data to include with the message for the individual communication device 112. A replacement key may be inserted into the message, subject, or body to indicate where the system should insert the specific data, like a first name, similar to a mail merge process. Each contact address is transmitted using the protocol or system specified by delivery method code to ensure that each message is sent to the contact addresses utilizing the appropriate communication protocol to get it directly to that device, or to intermediary devices that will translate it.

The alert notification service may be configured to address problems related to spam or unsolicited messages. In this embodiment, an authentication code may be included in the body of each message, so that alert originator 106 may use e-mail message rules to recognize this code in arriving e-mail; e-mail arriving without the code is rejected as spam. This authentication code can be changed at any time by alert originator 106.

Transmission center(s) 120 also receive responses from all supported communication devices using their respective protocols. For example, an alert recipient 108 may receive the alert message and use communication device 112 to provide a confirmation receipt or other response to alert notification service provider 102. When a reply is received at a transmission center 120, whether it is via e-mail, instant messenger, cellular phone or otherwise, transmission center 120 may update database 118 by sending a HTTP message to a web-based interface (e.g., user interface 116). A web site application, or other functionality, then updates database 118 and the results may be displayed to alert originator 106 via user interface 116.

In one embodiment, alert notification service provider 102 employs several transmission centers 120, and each center that receives an alert initiator message starts a “dead man” timer to monitor the primary transmission center's progress during an alert package transmission. If the primary fails to provide an update in the specified time or directly reports an error condition, then the secondary transmission center becomes the primary and initiates the sending of the alert by requesting an alert package. However, because each contact address is updated as it is sent, only those contact addresses that are still pending are sent to the transmission center for transmission to each device. Devices that were already sent before the failure may not be re-sent.

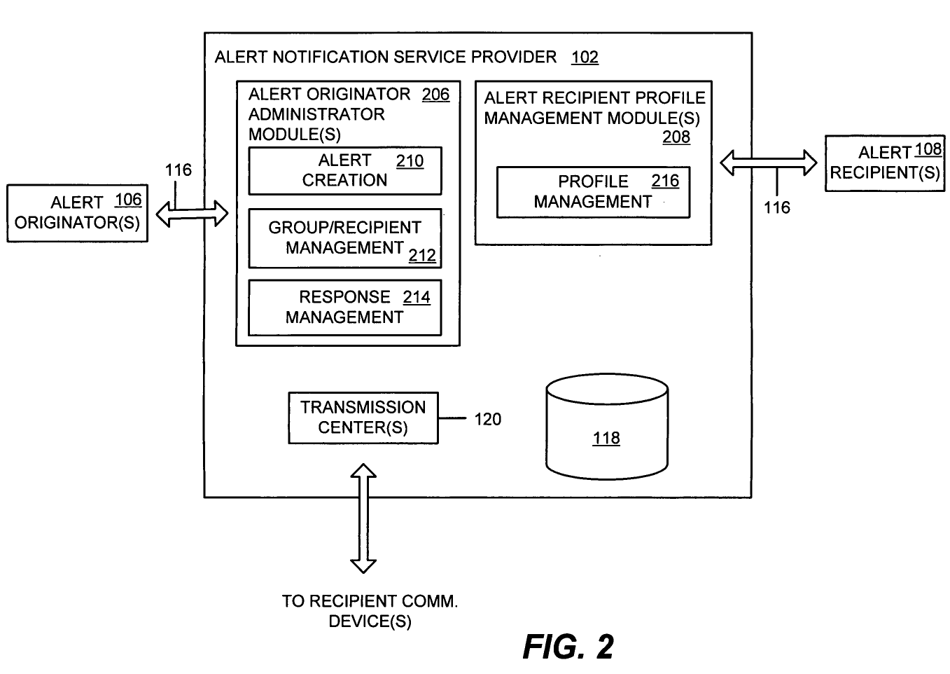

FIG. 2 illustrates a block diagram of various services, logic, or functionality supported by an embodiment of alert notification service provider 102. In this regard, user interface 116 may be implemented as a web-based application comprising various supporting modules. As illustrated in FIG. 2, the web-based application may comprise various modules for interacting with alert originators 106 (alert originator administrator module(s) 206) and alert recipients 108 (alert recipient profile management module(s) 208). As described in more detail below, administrator module(s) 206 may be configured to enable alert originators 106 to create alerts (module 210), manage responses to alert messages (module 214), and manage alert recipients 108 to receive alert messages (module 212). Profile management module(s) 208 provide the logic or functionality for enabling alert recipients 108 to configure and manage their user profile (profile management 216).

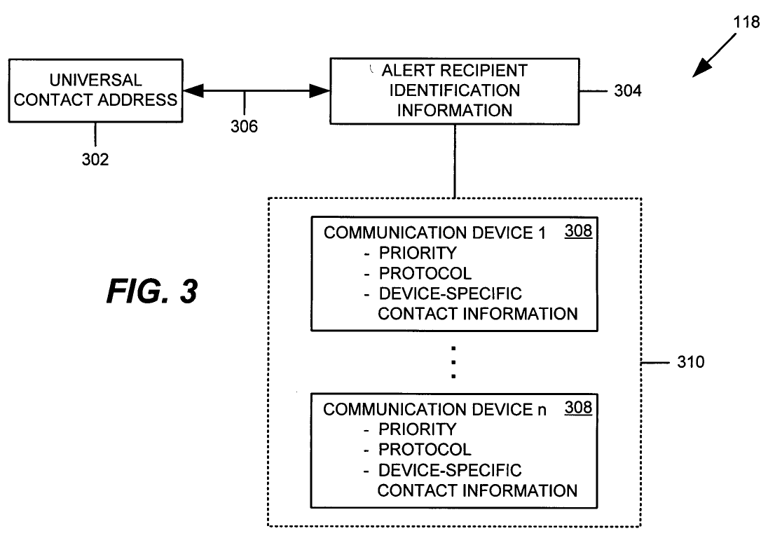

In general, alert recipient profile management module 208 comprises the logic, functionality, etc. for enabling alert recipients 10 to define the user profile. As illustrated in FIG. 3, in one embodiment, the user profile comprises contact information 308 for each communication device 112 to which the alert recipient desires the alert message to be delivered. Contact information 308 may specify device-specific contact information associated with a communication device 112 (e.g., address, phone number, e-mail address, user name, or pager number). One of ordinary skill in the art will appreciate that contact information 308 may also specify the particular protocol(s) to be implemented for delivering the alert message to the corresponding communication device 112. In situations in which alert recipient 108 defines multiple communication devices 112, contact information 308 may include priority information, which may be used to implement a sequential delivery scheme. In operation, the priority information defines the order in which the alert message should be delivered to communication devices 112. For example, the alert message may be delivered to a primary device on the first attempt. If a receipt confirmation message is not received in a predefined period of time or otherwise, the alert message may be delivered to secondary device(s) in accordance with the priority scheme.

As further illustrated in FIG. 3, the user profile links contact information 308 to a universal contact address 302 (line 306) for a particular alert recipient 108. The user profile may further include alert recipient identification information 304 (e.g., name, account number). As mentioned above, contact information 308 may be securely maintained in database 118 (dashed box 310) so that it cannot be accessed by alert originator(s) 106. Universal contact address 302, however, may be made accessible to alert originator(s) 106 via the web site.

Referring again to FIG. 2, in general, alert originator administrator module(s) 206 comprise the logic or functionality for enabling alert originator(s) 106 to initiate an alert message (or notification) to be sent to alert recipients 108 and to manage responses from alert recipients 108. From the perspective of alert originator(s) 108, the alert notification is delivered to alert recipient(s) 108 via the corresponding universal contact addresses 302. Alert creation module 210 may comprise various forms for creating and sending the alert notifications. The forms may provide a mechanism to select individuals, groups, or combinations thereof who will receive the alert. The forms may also enable alert originator 106 to specify the priority of the alert, a subject line, a message area, attachments, and optionally, the time the alert should be sent, and the frequency of successive alerts. Alert creation module 210 may also provide the ability to pre-program alerts. In this manner, alert originator 106 (or a group administrator associated with alert originator 106) creates an alert, which is assigned an identification number. When the group administrator is ready to send the alert notification, the alert notification service retrieves the pre-programmed alert, selects recipients through their unique universal contact address 302, makes any necessary modifications, and sends the alert notification. This type of alert may even contain pre-programmed recipients; thus only minor or no modification may be required at the time of dispatch.

The alert notification service may also enable alert originator(s) 106 to send alert messages from a mobile device. In this embodiment, the system sends an e-mail encoded with an authentication code, which is valid for a predetermined period of time (e.g., 24 hours), to the sender's mobile device. The sender can then send alerts by replying to the message, specifying the groups to whom the alert is to be sent, including a message, and subject. When the sender replies to the system's e-mail, the system recognizes the authorization codes, and dispatches the alert accordingly.

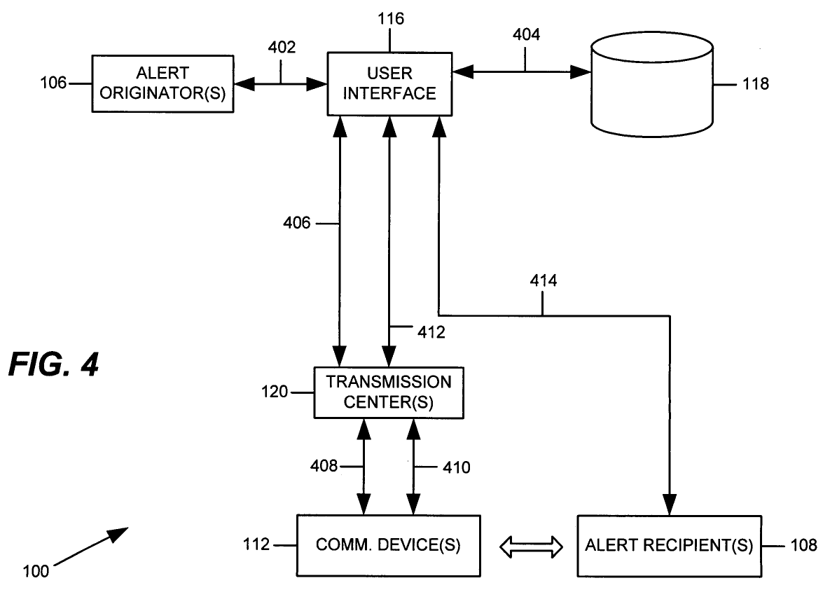

FIG. 4 is a combined block diagram and flow chart illustrating the operation of one of a number of embodiments of alert notification system 100. Line 402 illustrates the interaction between alert originator 106 and the web site via user interface 116. As mentioned above, alert originator 106 may create an alert to deliver to one or more alert recipients 108. Line 406 represents an alert package initiator e-mail and HTTP message containing the alert identification and the session identification being sent to each active transmission center 120. Transmission center 120 may create an individual message for each contact address using the global information in the header and the individual information from the detail lines, which include a personal alert code for each person and communication device 112, and sends the message to communication device(s) 112 indicated using the protocol (line 408). Each alert recipient 108 may respond to the alert in two ways, depending on the protocol of communication device 112. In one embodiment, the alert recipient replies using communication device 112 (line 410). In another embodiment, the alert recipient replies by posting a reply directly to the web site via http (line 414). If the response is via a reply, transmission center 120 captures the message, parses the content to extract the personal alert code, and creates a HTTP response that is posted to the web site (line 412). If the response is via a HTTP post directly from communication device 112, the results are posted directly back to the web site (line 414). The web site then updates database 118 with the status of each contact address as it arrives, and provides summary and detail reports on the progress of the alert for alert originator 106 (line 404).

The alert notification service may also support a registration functionality. For example, to enable the system to communicate with communication devices 112, once all contact information is entered, the system may step the user through a device verification process. This process may include capturing service provider names, if needed, and sending a test message to each communication device 112. Alert recipient 108 may be required to enter a verification code at the web site before the communication device 112 will be considered active, if desired.

The alert notification service may be configured (e.g., by alert originator 106 and/or alert recipient(s) 108) to support groups of universal contact addresses. Groups may be arranged like separate address books, except the owner of the address book does not update the information. The individual whose information is stored in the address book is the only one who can input updates. Once an individual updates the information, it is instantly viewable by a group administrator. However, the individual must give permission to a group administrator before the administrator can view the information, and the group member can remove the information at any time. This information is not publicly searchable, unless the individual allows this.

Within the groups there are two levels: group administrators and group owners. Group administrators can send and view alerts, invite new people to join the group, approve new members, and delete existing members. However, administrators may not assign or revoke any of the administrator's rights or privileges, and have only administration rights with respect to the specific group. A major advantage for group administrators is that they do not have to register each person and affirmatively ask for information. The alert notification service enables the administrator to invite a potential group member, and the potential group member supplies his or her own information to the alert notification service.

Group owners may have access to all groups in an account, and can create and delete whole groups. Group owners can assign rights and privileges to a specific group, to any single member or, multiple alert recipients 108.

Group members have the option of sponsoring other members of their groups. These group members are called sponsoring members. There are two types of sponsoring members: “branded,” wherein each universal contact address (UCA) 302 (FIG. 3) they pay for is “branded” with their own addressing scheme. For example, the format of a “branded” UCA may comprise MemberUCA.ClientUCA. The second type of sponsoring member is “non-branded,” in which the sponsored member can choose any available UCA, which is not branded to the sponsoring member's UCA. Additionally, group members can choose to remove themselves from a group at any time, and can block invitations to join groups from others.

There are two ways to invite people to join a group: first, an administrator can issue an invitation to join the alert notification service by sending the invitation to the primary and secondary e-mail addresses of each UCA; second, an administrator can simply send an e-mail to any e-mail address. In this manner, it should be appreciated that the alert notification service provides a convenient and cost-effective method for enabling an organization to provide alert notifications to its members, while maintaining the contact information of the members in a secure manner.

Groups can be set up such that group members are contacted sequentially until a response is received. In this case, group members are structured in order of priority. Messages are dispatched to one member at a time, with a pre-set time limit for receiving a response. If there is no response within the pre-set time limit, a message is sent to the next group member in order of priority. Once a group member responds, the message is terminated.

Additionally, groups may be organized into hierarchies, or sub-groups, thereby allowing a whole group to be categorized under one UCA. This is beneficial if a group of people need to be contacted at once, without having to know each group member's UCA.

The alert notification service allows groups to be compiled only upon express permission from the individual being invited into the group. Therefore, when compiling a group, a group administrator may send an invitation to a potential group member. The potential group member can either accept or decline the invitation, thereby allowing them to control access to their information, and decide to which groups they would like to belong.

The alert notification service also provides a means for tracking group members' responses based on the group administrator's structuring of groups. For example, a group administrator can send an alert to group A, which includes as a sub-set, group B. The group administrator can track responses from all of group A, or alternatively, just group B, thereby allowing the administrator to track the responses from just the subset, or the group as a whole.

A group administrator may also record private notes that are associated with a particular group member's profile. This information may be deleted when the group member is deleted, either by the group administrator, or by the group member.

It should be appreciated that the alert notification service provides a highly-customizable system for sending alerts to groups of people, or individuals, to one communication device 112, or many, at one time or in a specified sequential order. The alerts can be organized in a variety of ways based on circumstances and necessity. Alerts can be structured to utilize a particular communication device 1 12 or communication service based on the reason for sending the alert, the group sending the alert, or the type of alert.

In another embodiment, the alert notification service may utilize a personal alert code (PAC) that uniquely identifies the person and device contacted for a specific alert, which allows an alert recipient 108 to confirm receipt of the alert from multiple devices and protocols. Therefore, alert recipient 108 may confirm receipt of a message by using a different device or the same device. To do this, alert recipient 108 enters the personal alert code in their response message, or if using a voice response method, calling the support center and providing the PAC.

In certain embodiments, the alert notification system may include the capability to require a specific confirmation or any confirmation via confirmation rules. The group administrator can define that any response from the contacted person is considered a confirmation, or that a specific response must be received to be considered a confirmation. The system can also be configured to give first responders higher priority ranking for all their messages going out during an event.

As mentioned above, the alert notification service may support an alert creation form, which provides the mechanism to select individual group members, whole groups, or combinations thereof to receive an alert. The form may include a place to add groups or individuals to receive the alert, the priority of the alert, a subject line, a message area, a mechanism for including attachments, and optionally the scheduling of the time and frequency of the alert. Alerts can also be created and stored by group administrators. Therefore, if the alert needs to be sent, the group administrator need only insert groups or individuals to whom the alert will be sent, make any modifications, and send. These pre-set alerts can even include all information required, including group names, priority, subject, and message.

The alert notification service may also include a memo alert for enabling the group administrator to alert groups or individuals that they have a memo. The alert does not contain the memo, it merely alerts the recipient of the alert that there is a memo waiting to be read. The actual memo can only be seen if the member logs in to the web site, after which the memo can be seen. This allows for a secure closed communication system for private messages. Users can choose to view the memo using Secure Sockets Layer (SSL) or other supported secure level protocols.

A special group alert initiator message can be sent to a group administrator's contact addresses with a temporary password. To initiate an alert from that contact address, the administrator must reply and specify which pre-set alert to send. Because the message contains the password, it will authenticate and send the alert.

The alert notification service may also support a group chaining feature by which the alert notification is sequentially delivered to group members (based on a priority scheme) until a receipt confirmation, or other response, is received. The priority scheme may also be applied to delivery of alert notifications to the set of communication devices 112 in a user's profile. Each applicable UCA has associated with it a priority sequence number indicating which device is to be contacted first. This includes a time-out parameter that indicates the length of time to wait for an alert confirmation before moving on the next device in the sequence. For example, if a group member's information includes a cellular phone, an e-mail address, and a land-line telephone, the group member can rank the devices in the order they would like each device used.

A group member or administrator may establish their own priority sequencing number that indicates which device to try first, second, third, and so on. They can also establish the time-out parameter that will determine how long the system will wait for a response before sending an alert to the next person on the list. Alternatively, an alert can be sent to all group members at once, and sent to all of the members' devices at once.

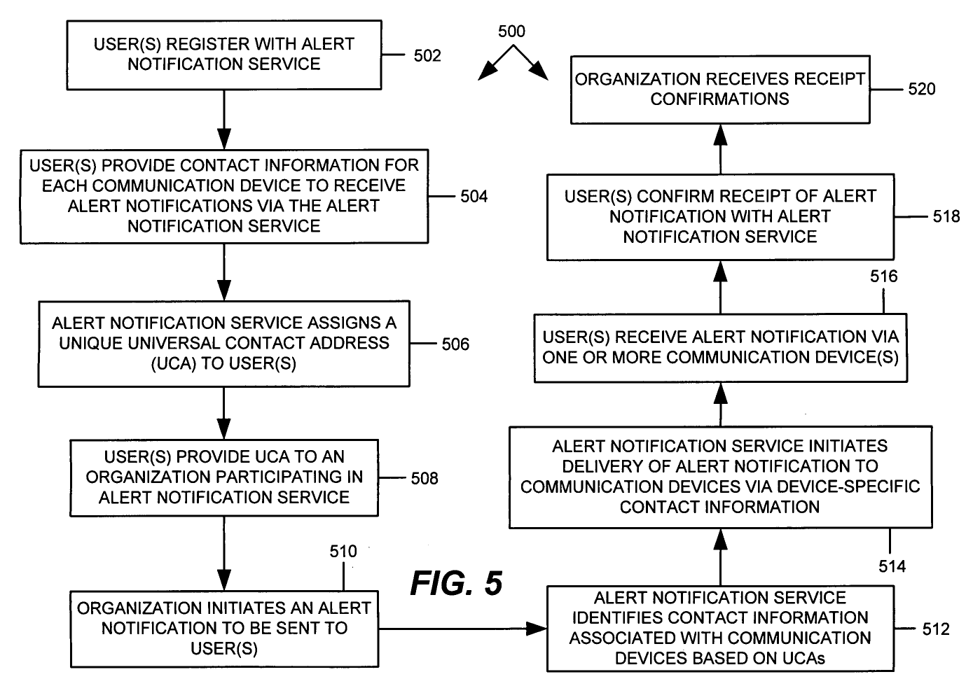

Referring to FIG. 5, one embodiment of an operational method for implementing an alert notification service will be briefly described. At block 502, user(s) (e.g., alert recipients 108) register with alert notification service via a web site or other registration means. At block 504, the user(s) provide the contact information for each communication device 112 to receive the alert notifications from the service. At block 504, the alert notification service assigns a unique universal contact address 302 to each user. As mentioned above, UCA 302 enables the alert notification service to deliver messages to communication device 112 without having to reveal the contact information to the alert originator. For instance, at block 508, a user may provide the assigned UCA 302 to an organization (or other individual) participating in the alert notification service as an alert originator 106. At block 510, the organization may initiate an alert notification to be sent to the user. At block 512, the alert notification service identifies the contact information associated with communication devices 112 based on UCA 302 corresponding to the user. The alert notification service may perform a look-up in the user profile of database 118 (FIG. 3). At block 514, the alert notification service initiates delivery of the alert notification to communication devices 112 via the device-specific contact information and/or protocol(s). At block 516, the user receives the alert notification via one or more of communication devices 112. At block 518, the user may confirm receipt of the alert notification (e.g., directly via communication device 112 or via the web site). At block 520, the organization receives the confirmation or other response from the user.

One of ordinary skill in the art will appreciate that various aspects of the systems, methods, computer programs, and related equipment for providing the alert notification services described above may be implemented in software, hardware, firmware, or a combination thereof. Accordingly, in one embodiment, at least a portion of the alert notification service is implemented in software or firmware that is stored in a memory and that is executed by a suitable instruction execution system or processor. It should be appreciated that various process descriptions, functionality, logic, and services described above represent modules, segments, or portions of code which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, various logical and/or functional aspects of the alert notification service may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments, particularly any “preferred” or “exemplary” embodiments, are merely possible examples of implementations, merely set forth for a clear understanding of the principles of the invention. Many variations and modifications may be made to the above-described embodiment(s) of the invention without substantially departing from the spirit and principles of the invention. All such modifications and variations are intended to be included within the scope of this disclosure and the present invention and protected by the following claims.

1. A system for providing an alert notification service, the system comprising:
a web-based user interface for interfacing with an alert originator and a plurality of alert recipients, the web based-user interface comprising:
an alert recipient profile management module configured to enable the plurality of alert recipients to define a profile comprising contact information for at least one communication device to receive an alert notification from the alert originator, the contact information linked to a unique universal contact address to be used by the alert originator to identify the corresponding alert recipient; and
an alert originator administration module configured to enable the alert originator to initiate an alert notification to be sent to the plurality of alert recipients based on the corresponding unique universal contact addresses;
a data store for storing the profiles associated with the alert recipients; and
a transmission center for delivering the alert notification to the communication devices associated with each of the plurality alert recipients based on the contact information in the profile for the corresponding unique universal contact address.

2. The system of claim 1, wherein the unique universal contact address comprises a private key.

3. The system of claim 1, wherein the unique universal contact address is accessible by the alert originator and the contact information for said one communication device is privately maintained in the data store.

4. The system of claim 1, wherein the profile comprises a priority sequence defining the order in which the alert notification is sent to said communication device associated with a particular alert recipient.

5. The system of claim 1, wherein the profile comprises protocol information for said communication device which specifies a communication protocol to be implemented by the transmission center for delivering the alert notification.

6. The system of claim 1, wherein the alert originator comprises an organization, and the plurality of alert recipients comprise members of the organization.

7. The system of claim 6, wherein the organization sponsors the members' participation in the alert notification service.

8. The system of claim 1, wherein the alert originator administration module is configured to enable the alert originator to invite at least one of the plurality of alert recipients to join the alert notification service.

9. The system of claim 1, wherein the transmission center receives a receipt confirmation message from said communication device indicating that the alert notification was received.

10. The system of claim 1, wherein the web-based user interface is configured to enable the plurality of alert recipients to confirm receipt of the alert notification.

11. The system of claim 1, wherein the web-based user interface comprises a response management module for providing alert notification reporting services to the alert originator.

12. The system of claim 1, wherein the web-based user interface is configured to enable the alert originator or the plurality of alert recipients to define an alert notification group.

13. The system of claim 12, wherein the transmission center supports a group chaining service which enables a first alert notification group to reference a second alert notification group.

14. The system of claim 1, wherein the unique universal contact address is publicly maintained by the alert notification service and the contact information for the at least one communication device is privately maintained.

15. The system of claim 1, wherein the transmission center supports communication to at least one of a mobile phone, a personal digital assistant, and an integrated personal communication device.

16. A method for providing an alert notification service, the method comprising:
enabling at least one alert recipient and an alert originator to register with an alert notification service via a web site;
receiving, from the at least one alert recipient via the web site, contact information for at least one personal communication device to receive an alert notification from the alert originator via the alert notification service;
associating the contact information with a private universal contact address in a database;
enabling the alert originator to initiate the alert notification to be sent to the at least one personal communication device based on the private universal contact address; and
delivering the alert notification to the at least one personal communication device by identifying the contact information associated with the private universal contact address.

17. The method of claim 16, further comprising receiving a receipt confirmation from said alert recipient via one of the web site and said personal communication device.

18. The method of claim 16, wherein the delivering the alert notification involves a sequential priority scheme which defines the order in which the alert notification is to be sent to said personal communication device.

19. The method of claim 16, further comprising:
enabling the at least one alert recipient to manage a profile containing the contact information for the at least one personal communication device; and
enabling the alert originator to manage the alert notification service.

20. An alert notification service provider comprising:
means for interfacing with at least one alert recipient and an alert originator via a web site;
means for managing a user profile associated with the at least one alert recipient, the user profile associating contact information for at least one mobile communication device to receive an alert notification from the alert originator with a private universal contact address accessible by the alert originator; and
means for delivering the alert notification to the at least one mobile communication device based on the private universal contact address.
